(19) United States
(12) Patent Application Publication
(10) Pub. No.: US 2009/0305626 A1
(43) Pub. Date: Dec. 10, 2009

(54) PREVALIDATED, MODULAR GOOD MANUFACTURING PRACTICE-COMPLIANT FACILITY

(76) Inventor: Ernest G. Hope, Portola Valley, CA (US)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/096,302

(22) PCT Filed: Dec. 5, 2006
(86) PCT No.: PCT/US2006/046615

§ 371 Date: Jun. 8, 2009

Related U.S. Application Data
(60) Provisional application No. 60/742,255, filed on Dec. 5, 2005.

(51) Int. Cl. B01L 1/04; B65D 88/00; B23P 19/04

(52) U.S. Cl. 454/187; 220/1.5; 29/700

(57) ABSTRACT

The invention is directed to a ready-to-use modular cleanroom and facility, in particular for the production of drugs and biological substances, which is equipped with pre-approved manufacturing equipment cores. The modular cleanroom is implemented in the interior space of a container, such as a standard shipping container, and includes at least one bioreactor station. The modular facility can be installed on-site from pre-approved cleanroom modules without further regulatory approval. The cleanroom and facility comply with FDA-approved good manufacturing practices (GMP) and good laboratory practices (GLP).

### FIELD OF THE INVENTION

The invention is directed to a ready-to-use modular facility, in particular for the production of drugs and biological substances, which is preassembled and equipped with pre-approved manufacturing equipment cores.

### BACKGROUND OF THE INVENTION

Regulatory approval of production of drugs and biological substances requires strict adherence to laws and regulations that are promulgated with the goal of establishing safe and effective manufacturing facilities and products. As a non-limiting example, in the United States, certain Good Manufacturing Practices (GMP, also referred to a cGMP or “current GMP”) and Good Laboratory Practices (GLP) are established by regulation and implemented by the FDA (the U.S. Food and Drug Administration) CDER (Center for Drug Evaluation and Research) and CBER (Center for Biologics Evaluation and Research) with regard to drugs and biologics. Similar GMP and/or GLP laws are implemented worldwide, for instance in the EMEA.

GMP practice, and its worldwide equivalent, requires establishment of clean, safe facilities as well as quality control (QC) procedures, in particular SOPs (Standard Operating Procedures), WI (Work Instructions) and DMR (Device Master Records) as well as process-certified equipment (e.g. the “CE” mark of Europe) as may be applied by local medical device laws, relating to manufacturing, inspection and reporting. As such when facilities currently are implemented, a building is built only with particularly pure, non-leaching, piping and soldering particle emission-free ducting and food-grade or higher floor and wall-coverings, and then is fitted with all necessary equipment. At each point of installation, a different regulatory inspector has to visit the site of implementation and review the component under his or her purview, such as plumbing, air-handling, etc. Only after approval, can the building progress to the next stage and the facility is inspected one or more times by the FDA or other designated regulatory agency. Substantial paperwork is newly created for each lot of materials used, for example, mill certification of any lot of plumbing. This is repeated for each material type used in the facility. This process is very expensive, involving long ramp-up times, inevitable delays and exorbitant costs, including legal fees. These costs and delays not only arise as a necessary part of the GMP approval process, but as a result of customization of the facility to fit the physical structure of the building in which it is established as well as a fallout from the differences of each specific facility, the different equipment used in each different facility, and the relative experience or inexperience of the parties involved. In fact, oftentimes small companies with little track record with the FDA face substantial burdens in proving their ability to meet approval requirements. Consulting companies have sprung up with their entire purpose being navigation of GMP laws. Other companies own GMP-compliant manufacturing facilities, but charge exorbitant prices for access to their facilities and services, and typically not in a geographical location convenient to a researcher or prospective manufacturer.

The consequence of all the aforementioned costs and delays is an expensive facility, and expensive product. This expense can act as an entry barrier to many small companies, preventing adequate testing and manufacture of a given drug product or biologic. Many drug products, for example recombinant products, need only to be produced in nanogram, microgram and milligram quantities for testing. Many drugs, such as those identified by the FDA as orphan drugs, may never be needed in quantities sufficient to justify the expense of establishing a large-scale GMP-compliant facility. As such, efficiencies must be created in establishing a GMP-compliant manufacturing facility that does not serve as an entry barrier to companies or individuals.

Cleanroom specifications and modular cleanroom facilities are well-known in the art. Several companies have made a small and expected step in providing cleanroom facilities that are suitable for GMP-approved uses. Companies, such as MW Zander, Stuttgart (Germany) and Terra Universal, Fullerton, Calif. (USA), provide modular cleanroom subunits that can be assembled on-site to produce a cleanroom. These companies provide the basics, walls, floors, cabinets, air-cleaning, but, aside from the savings in time it takes the assemble a like structure from individual components as opposed to the modular systems sold by these companies.

Numerous US and international patents and patent applications are directed to various cleanroom configurations, structures and sub-components. There are a number of main fabrication styles for cleanrooms. They are conventional, modular hard-wall, modular soft-wall, mini environment, and micro environment. Conventional construction is the most common type, and these are generally permanent structures. Modular cleanrooms are constructed on site from pre-cut and assembled components, such as walls, ceiling grid struts and other components. Hard-wall cleanrooms provide the rigidity and durability of a freestanding room. The walls of the cleanroom are of a solid material, rather than fabric. The walls of modular soft-wall cleanrooms are constructed from fabric or plastics, either of free-hanging strips or stretched tightly over a frame. Mini environments are localized clean environments. They are created around a specific tool, or only within a tool, to protect materials in or around the tool from atmospheric exposure. Likewise, micro environments are similar, but they are smaller, are used to protect single or multiple items instead of encapsulating the manufacturing tool.

A typical cleanroom, such as a modular cleanroom, comprises walls, a floor and a ceiling, optionally having suitable windows and office space, including seating, desks, shelves, other furniture and a personal computer or computer workstation. Air service is handled by a standard filter-fan unit, as are commercially available, and typically is a laminar flow system, and includes mechanical (such as HEPA) and, optionally, chemical (for example, carbon or zeolite) filtration. Cleanliness of the room is managed by air-lock systems. The filter-fan unit may be configured as an integral part of the cleanroom facility. Water, air, steam, electrical, lighting, including UV lighting to maintain sterility and gas (for example CO₂, propane, liquid or gaseous N₂) may be configured into the facility and preferably meet or exceed all reasonable local codes in addition to GMP standards. See, as non-limiting examples, U.S. Pat. Nos. 6,158,186, 6,358,139, 6,867,682 and 6,955,595, which are incorporated herein by reference in their entirety for their description of various cleanroom systems. These patents describe a variety of cleanroom structures, components, assembly methods and the like.

It would therefore be desirable to improve over the present state of the art by providing a modular cleanroom and a modular facility that accelerate the regulatory approval process, in particular FDA approval in the pharmaceutical and biotech industry.

### SUMMARY OF THE INVENTION

Regulatory approval of pharmaceutical and biological manufacturing facilities is rigorous and is conducted in multiple stages. Provided herein are methods and modular units that combine the manufacturing of ready-to-use life science cleanrooms in a proprietary fashion with the co-sale of certain and universally necessary pre-configured biopharmaceutical manufacturing equipment cores, the development and co-sale of “generic & pre-approvable” GMP standard manufacturing process designs, and the regulatory pre-validation of such pre-fabricated units prior to the sale/lease of such turnkey labs to time-critical biopharmaceutical manufacturing projects/companies. Pre-validation of these fully equipped mobile GMP manufacturing rooms based on sets of “generic” GMP manufacturing processes will especially serve the needs of venture capital-backed early stage biotech/biopharmaceutical companies.

The main idea of the present invention is to provide the customer, e.g. a biotech company, with a cleanroom facility that is depending on the embodiment, basically ready-to-use or about to be ready-to-use for product manufacturing. The use of the cleanroom facilities of the present invention spares the customer valuable time in establishing a GMP approved process/facility as the customer does not need to go through the multi-step GMP approval process himself which is very time consuming and thus often detrimental for the economic development of the company. Instead, the customer can use the mobile pre-validated cleanroom facilities according to the present invention. Therefore, the customer can basically immediately start with the manufacturing process and does not use time (months to years) in order to establish a GMP side.

According to one embodiment, the cleanroom facilities respective entities according to the present invention are established/build in proximity to the respective regulation authority and are transported upon completion to the customer. This feature saves time in the whole GMP establishing process as it is easier for the authorities to examine and authorize the individual steps of creating the cleanroom facility if they are in proximity to the authorities. This feature makes traveling of the examiners throughout the country to the GMP manufacturing sites obsolete what is, however, necessary with the standard methods known in the state of the art. According to a further embodiment, several basically identical cleanroom entities are created/established simultaneously, thereby again saving time in the approval process as identical steps can be approved simultaneously.

Furthermore, the cleanroom facility according to the invention comprises the basic technological equipment necessary in order to render the cleanroom facility GMP approved or GMP approvable. The cleanroom facility according to the present invention is thus pre-equipped especially with e.g. a bioreactor.

The facility or portions thereof may be maintained at desired levels of environmental cleanliness as are know in the art. US Federal Standard 209D provides a qualified and standardized method for measuring how clean the air is in a cleanroom. Six US classes have been established to designate cleanroom cleanliness. The class number refers to the maximum number of particles bigger than one-half of a micron that would be allowed in one cubic foot of cleanroom air. A Class 100 cleanroom, for example, would not contain more than 100 particles bigger than half a micron in a cubic foot of air. The US classes with their equivalents are: Class 1 (ISO 3), Class 10 (ISO4), Class 100 (ISO 5, Class A/B), Class 1,000 (ISO 6), Class 10,000 (ISO 7, Class C), and Class 100,000 (ISO 8, Class D).

### BRIEF DESCRIPTION OF THE DRAWING

Other features and advantages of the present invention will be more readily apparent upon reading the following description of currently preferred exemplified embodiments of the invention with reference to the accompanying drawing. The dimensions indicated in the drawing are in meters and are for example only. Variations in dimensions, as well as in the location of the depicted elements are a matter of design choice and within the abilities and imagination of those of skill in the relevant arts.

FIG. 1 shows a first exemplary embodiment of a modular cleanroom arranged according to the present invention;

FIG. 2 shows a second exemplary embodiment of a modular cleanroom arranged according to the present invention;

FIG. 3 shows a third exemplary embodiment of a modular cleanroom arranged according to the present invention;

FIG. 4 shows a fourth exemplary embodiment of a modular cleanroom arranged according to the present invention;

FIG. 5 is a side view of another exemplary embodiment of a modular cleanroom arranged according to the present invention;

FIG. 6 is a plan view of the embodiment shown in FIG. 5; and

FIG. 7 is a schematic plan view of an airlock system provided in a half-length (20 foot) container.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

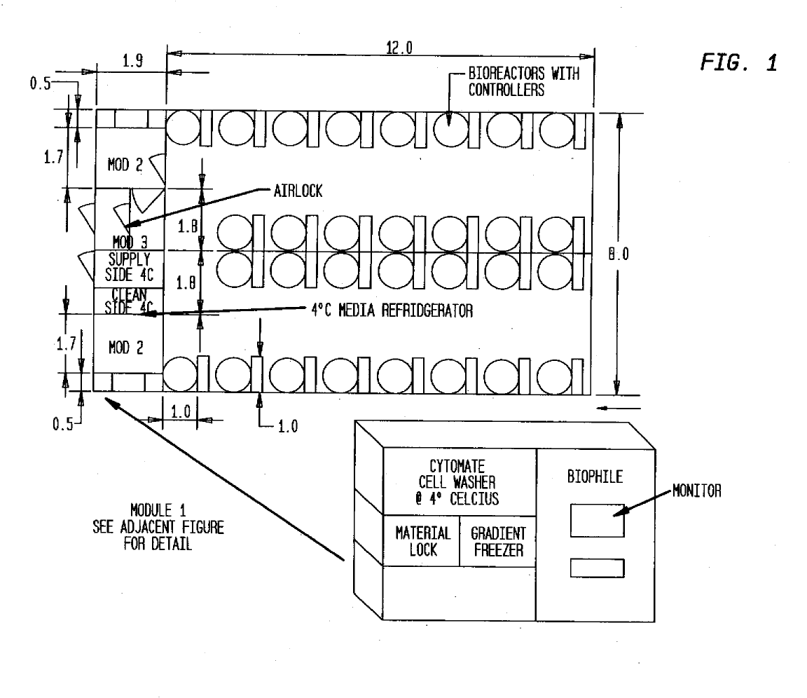

All structures shown in FIGS. 1-4 are modular in nature and can be arranged side-by-side or stacked on top of one another to create a larger facility. This embodiment is especially suitable also for arranging an entity comprising several cleanroom facilities approved or approvable for different GMPs and thus different manufacturing processes.

Turning now to the drawing, and in particular to FIG. 1, there is shown schematically a first cleanroom facility, providing a central air-lock with a media room immediately adjacent to the air lock (Mod 3, referring to “Module 3, indicating that the facility may be prepared from modular components as are commercially available, as described above), facilitating transfer of media and other supplies to and from the room. The media room is typically maintained at a temperature of about 4° C. The main room of the facility includes one or more bioreactors and their controllers. The facility also includes one or more processing stations (Mod. 2), which can be pre-configured as a single module or prepared from individual components. Once cells or cell products are prepared in the bioreactor(s), the material can then be processed at the processing station, yielding a (typically, but not exclusively) frozen product. In the embodiment shown in FIG. 1, the processing module contains a material lock (airlock), a cell washer, a gradient freezer and a freezer. Non-limiting, but exemplary commercial products are shown in FIG. 1, including a Cytomate cell processing system (Baxter, Inc. of Deerfield, Ill.), and a Biophile freezer (Biophile, Inc. of Charlottesville, Va.).

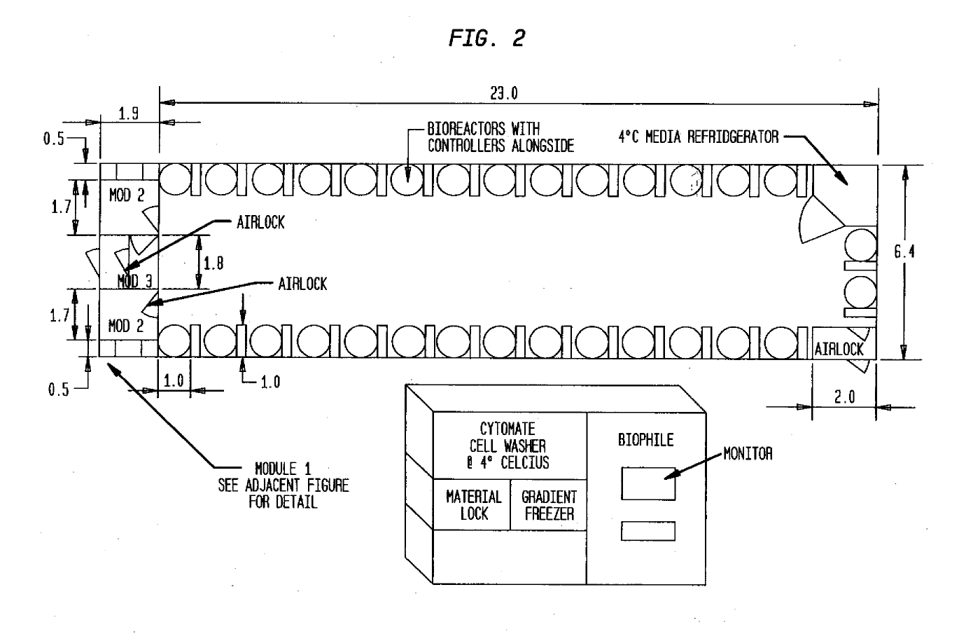

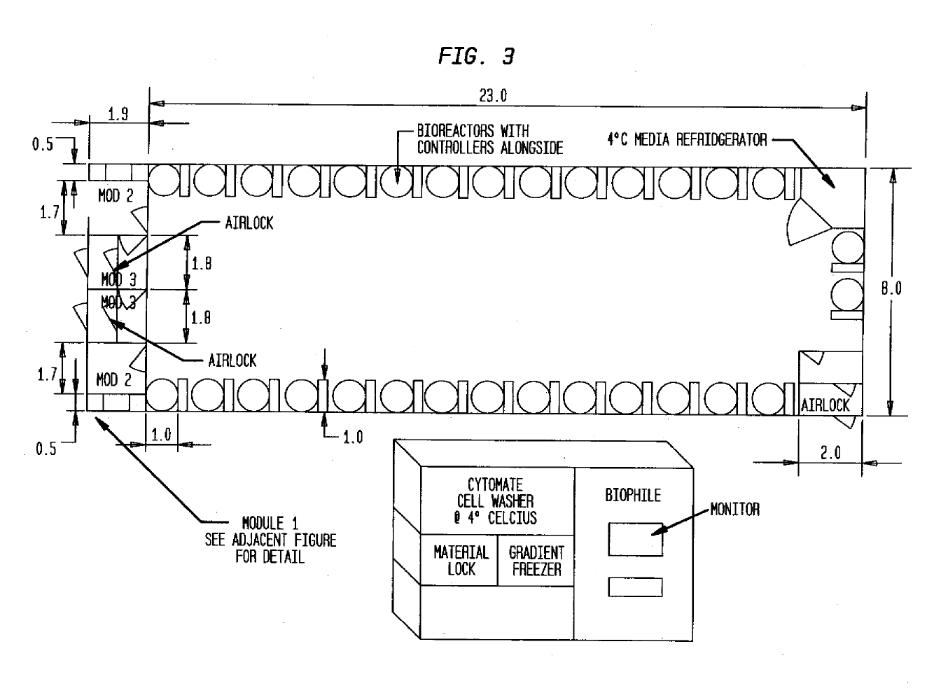

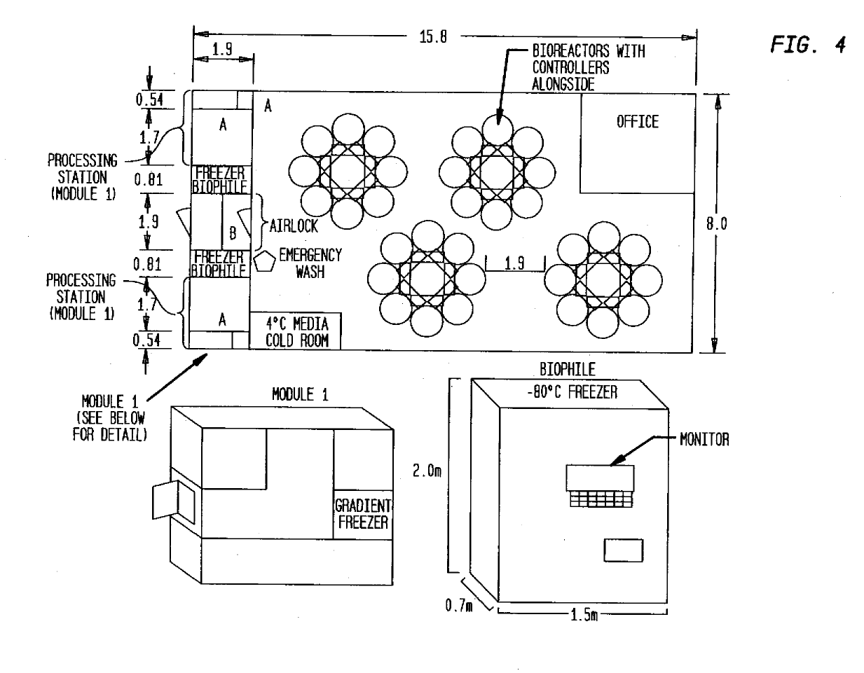

FIGS. 2 and 3 show alternate configurations of the facility shown in FIG. 1, which include different bioreactor placements, multiple airlocks and a media storage unit in a different location as compared to FIG. 1. FIG. 4 shows yet another exemplary embodiment including an office, bioreactors arranged in rosettes and a somewhat different configuration of the processing components. The letters “A,” “B” and “C” denote Class A, B and C environments, which may be maintained by common methods, for example and without limitation, by laminar flow supported by a filter-fan unit. In the processing stations flanking the airlock, the Class A area may be created by a hood or soft-wall mini-environment. The media room optionally has an external airlock access, not shown.

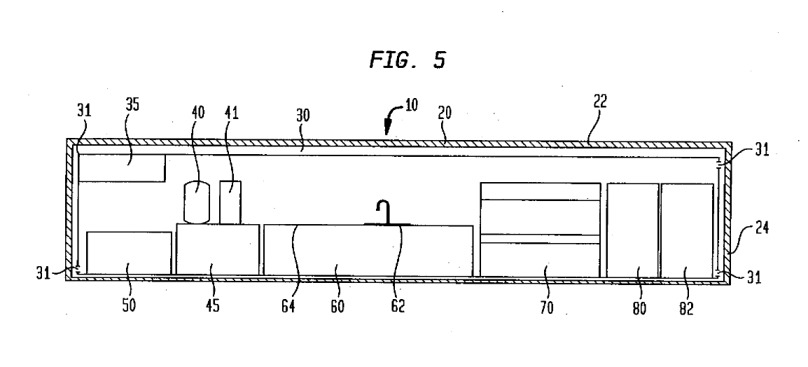

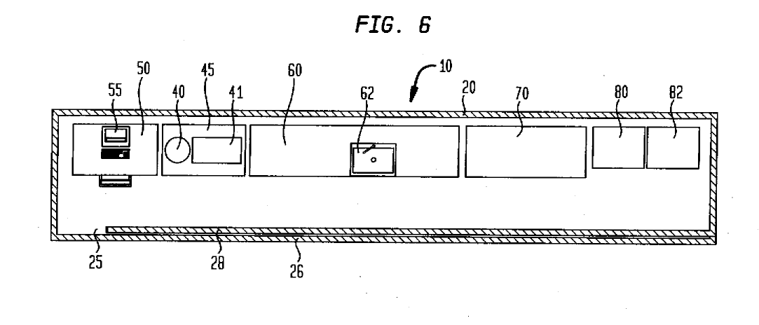

Distribution of the facilities described herein is accomplished by standard routes. Advantageously, the facilities are mobile as this feature allows the creation/establishment of the cleanroom facilities in proximity to the approval authorities (this saves time) and the transport to the actual place where the facility is needed by the customer. In one embodiment, the facility is configured within standard transport containers, which are provided in a limited number of configurations. These containers are typically, twenty or forty feet in length, eight feet in depth and eight to nine feet high. The embodiment shown in FIGS. 2 and 3 are conducive to configuration, shipping and implementation in a container that is of standard shipping size, thereby facilitation distribution of the facility. In use, one or more of the containers can be stacked and/or positioned side-by-side to produce a larger facility. Such a larger facility may comprise containers/cleanroom facilities approved for different manufacturing processes. FIGS. 5-7 show schematically an exemplary embodiment implemented within one or more shipping containers. FIG. 6 is a plan view of the embodiment shown in FIG. 5. In FIGS. 5 and 6, facility 10 includes a container 20 having an air service access port 22 to which a filter-fan unit can be attached, and a service access port 24 providing access to water, steam, gas and electrical service to facility 10. Also provided is a passageway 25, optionally containing a door. In use, air service access port 22 and service access port 24 are covers that are kept in place during distribution of facility 10, and are removed for installation. FIG. 6 shows removable wall 26, which is removed upon installation to expose internal wall 28. During shipment, a plastic sheet may be placed between removable wall 26 and internal wall 28 to better seal the inside of the container. Upon remove, removable wall 26, as well as ports 22 and 24, may be discarded, or it can be re-cycled for use in shipping other facilities.

Facility 10 includes an air duct system 30, shown schematically only as the air handling configuration is a matter of design choice. In one embodiment, filter-fan unit 35 may be included in the facility, in which case air service port 22 is not removed. Air duct system 30 includes openings 31, which are shown schematically and denote air intake and exhaust into duct system 30. Openings 31 may be configured in the walls or ceiling of the facility 10. In one embodiment, openings 31 are placed in the ceiling and floor of the facility, in which case, air flow is preferably in a downward direction.

Facility 10 also includes one or more bioreactors 40, including a controller 41 and a stand 45. A desk 50 may be provided, along with shelves and storage cabinets 60. A computer 55 is shown in FIG. 6. A sink 62 is shown, along with work surface 64 (a counter). A hood 70 is shown in FIGS. 5 and 6, which includes a cell processing station (not shown), as described above, including a cell washer, such as the Cytomate cell processing system, described above, and a freezing unit. Freezer 80 is provided for product processing and may be a Biophile freezer as described above. Lastly, a refrigerator 62 is provided for media storage.

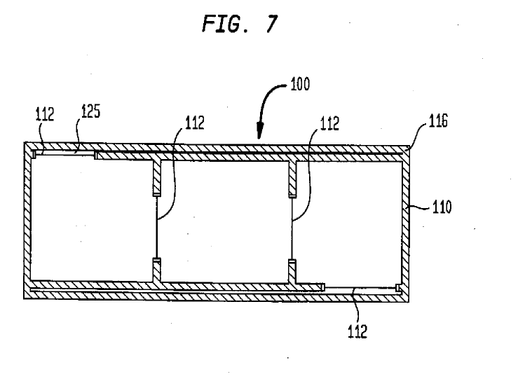

FIG. 7 is a schematic plan view of an airlock system provided in a half-length (20 foot) container. Airlock facility 100 includes an interior wall system 110 including doorways 112. Facility 100 is shipped with an external removable wall 114 and an internal removable wall 116. During shipment, a plastic sheet may be placed between removable walls 114 and 116 and internal wall 110 to better seal the inside of the container. Upon removal, removable walls 114 and 116, as well as service ports (for example, air, electrical and water, not shown), may be discarded, or it can be recycled for use in shipping other facilities. On installation of airlock facility 100, internal removable wall 116 is removed and airlock facility 100 can then be affixed to facility 10 shown in FIGS. 5 and 6. Rubber, silicon or other suitable gasket material may be provided at desired areas of connection between airlock facility 100 and facility 10, especially about door 112 in passageway 125. Optimally, passageway 125 aligns with passageway 25 of facility 10 and suitable gasket materials fill any gaps between passageways 25 and 125. It should be readily apparent that, when aligned, only one of passageways 25 and 125 needs a door and the door can be placed in either of passageways 25 and 125.

The diagrams provided in FIGS. 1-7 are intended for illustration purposes only and are intended to show a few of a large number of possible physical cleanroom configurations.

To facilitate regulatory approval of these facilities, they are implemented using only materials and equipment that is acceptable by regulatory authorities under GMP standards. “GMP” or “GMP standards” is used herein as shorthand indicating any an all governmental and local regulatory schemes that regulate implementation and use of the facilities described herein. This term is thus not strictly limited to GMP standards but also refers to equivalent/corresponding regulatory approval procedures necessary in order to be able to operate a cleanroom facility according to the present invention (e.g. for stem cells). Such approvals/approval procedures are thus comprised by the term “GMP”, respectively “GMP standard”. GMP standards apply to structures, services to the structures (for example, air, water, gas, steam, etc.), equipment within the structure, and operating and quality control provisions. Because most biotechnology applications involve use of a limited number of biological systems, including, without limitation, bacterial systems such as E. coli, yeast systems such as S. cerevisia, Sf9 and Sf21 insect cells, Chinese Hamster Ovary (CHO), hybridoma, human blood cells (lymphocytes and cytokine-stimulated lymphocyte cultures) and stem cells the facilities may be standardized, and GMP compliance geared towards the implementation of culture system for growing this limited number of cell types. This has the advantage that the customer can order a GMP pre-validated cleanroom facility according to the invention for the production of his individual product according to the pre-validated manufacturing process approved or approvable for the respective cleanroom facility. This for the following reasons:

Irrespective of their end use, in most cases, the growing, harvesting and storage of biological material/products such as the cells or cell products of these cultures, including, for example and without limitation, antibodies, protein products, chemical compounds and compositions and cell mass requires identical equipment. For example, recombinant proteins can be produced by CHO cells in a typical hollow-fiber bioreactor. Likewise, lymphocyte cell mass can be produced in bioreactors containing agitated media, such as stirred or aspirated bioreactors. In each case, a standard bioreactor configuration can be provided, pre-configured in or otherwise distributed with a cleanroom facility that is “approvable” or pre-approved, should a regulatory agency, such as the FDA, implement such an approval process. By “approvable” it is meant that all components of the facility meet or exceed all applicable regulatory standards as they are configured in the facility. In the context of the present disclosure, the facility is approved or approvable when distributed to a site of implementation. This has the advantage that the cleanroom facility is already ready to use for manufacturing the customer's product which saves the customer time and money.

Because GMP standards require standard operating procedures with respect to everything from cell culture, quality control, cleaning and record-keeping, the facility preferably is distributed with standard operating procedure (SOP) documentation, including instructions and checklists that meet GMP requirements. In one implementation, a computer device, such as a personal computer system comprises software (or in more general terms, a process or series of processes) that provide or otherwise implement SOPs. By “SOP documentation” it is therefore meant documentation (collectively, instructions, checklists, forms and other materials commonly used in the implementation of GMP standards in an facility), whether or not implemented in paper or by a computing device. Preferably the facility is distributed commercially with SOP documentation that is complete in that additional SOP documentation is not needed to implement the facility for the desired use, or substantially complete in that only SOP portions pertinent to the particular end-use are omitted from the SOP documentation. The SOP basically describes how the product is manufactured. Some authorities require the implementation of the SOP's prior to giving GMP approval, it is advantageous that the SOPs are provided together with the physical cleanroom facility.

As stated above, SOP documentation is preferably distributed with the physical facility. As such, a distributor of the physical facility may forward the SOP documentation and related computer hardware, as is necessary, within the physical facility or separately from the facility. Third parties, in collaboration with the distributor of the physical facility, for example and without limitation the distributors agents, also may distribute the SOP documentation in conjunction with the sale or lease of the facility.

Furthermore, other potentially necessary documentation may also be provided that is required according to GMP practice, such as e.g. WI (Work Instructions) and DMR (Device Master Records) as well as process-certified equipment (e.g. the “CE” mark of Europe) as required by local medical device laws, relating to manufacturing, inspection and reporting.

As used herein, the term “bioreactor(s)” refers to equipment suitable for handling biological material and it refers in particular to any suitable cell culture system, and includes suspension or adherent cell culturing devices, including without limitation: stirred cultures, agitated cultures, aspirated air-lift cultures, turbine-agitated bioreactors, vibro-mixer reactors, reactors with more than one incubation chamber, reactors that facilitate sterile harvesting and/or sampling of the cells, systems that employ membrane or other enclosures (for example and without limitation, enclosures formed of any plastic or synthetic material, including infusion bags, fluorocarbon bags, and dialysis or gas-permeable membranes, especially in the case of static cultures), hollow-fiber cultures, flexible-substrate cultures, flask cultures and plates. In agitation systems, and means of agitating the cells and media may be employed. Vessels may be formed from plastic, Teflon®, glass, or stainless steel. The cells can be grown on solid or semi-solid carrier support systems. The supports can be static or agitated. Flasks and plates are certainly less preferred as open systems, as compared to closed culture systems, which automatically feed the cells and monitor and control culture conditions without manual passage or intervention. The cells preferably are grown in “closed” systems, such as bioreactors. They can be grown, for example and without limitation with the use of rocking platforms, tumblers, shaken or stirred bioreactors without electrodes, or more advanced systems using electrodes or other measuring probes or devices, such as, without limitation, pO₂, CO₂, RPM, temperature and cell density/OD probes). The cells may be grown with continuous feeding and harvesting. In addition it may be useful to employ analog or digital data collection. Suitable bioreactor systems are commercially available from New Brunswick Scientific of Edison N.J. and Sartorius AG of Goettingen, Germany, among many other manufacturers and distributors of such systems.

Manufacturing processes facilitating the production of approvable or pre-approved facilities include production of the facility units in lots. Mass production of the facility in lots promotes standardization of the facility components and better tracking of materials, promoting lower manufacturing costs as well as reproducibility required for approval or approvability of the facility under GMP standards, thereby removing many of the long, bureaucratic steps during regulatory review.

Having now fully described this invention, it will be understood to those of ordinary skill in the art that the same can be performed within a wide and equivalent range of conditions, formulations and other parameters without affecting the scope of the invention or any embodiment thereof. All publications, patents and patent applications mentioned in this specification are herein incorporated by reference into the specification to the extent of their technical disclosure, to the same extent as if each individual publication, patent or patent application was specifically and individually indicated to be incorporated herein by reference.

What is claimed as new and desired to be protected by Letters Patent is set forth in the appended claims and includes equivalents of the elements recited therein:

1. A modular cleanroom comprising:
a container having standard dimensions of a shipping container and defining an interior space;
one or more bioreactor stations with a bioreactor located in the interior space of the container;
filtered air service provided to the interior space of the container;
water service provided to the interior space of the container; and
one or more work surfaces located within the interior space the container;
wherein the modular cleanroom facility is pre-approved or pre-approvable under a GMP standard for distribution to an implementation site.

2. The modular cleanroom according to claim 1, further comprising one or more of the following elements located in the interior space of the container:
a hood;
gas service;
a computing device;
one or more storage compartments;
GMP documentation; and
an instruction manual.

3. The modular cleanroom according to claim 2, wherein the gas service is one or more of nitrogen gas service, compressed air service, steam service, carbon dioxide service and natural gas service.

4. The modular cleanroom according to claim 2, wherein the computing device is a personal computer and the GMP documentation is stored on the personal computer.

5. The modular cleanroom according to claim 2, wherein the instruction manual contains at least one of a checklist and operating instructions.

6. The modular cleanroom according to claim 1, wherein the shipping container is a standardized freight container having a length of about 20 feet (6.1 meter) or about 40 feet (12.2 meter) and a width of about 8 feet (2.45 meter) or about 9 feet (2.75 meter), and a height of about 8 feet (2.45 meter).

7. The modular cleanroom according to claim 1, further including standard operating procedure (SOP) documentation.

8. The modular cleanroom of claim 7, wherein the SOP documentation is substantially complete or complete for implementation of an end use of the cleanroom facility.

9. The modular cleanroom according to claim 1, further comprising lighting, a media room, an airlock, a refrigerator, a freezer, a gradient freezer, a freezing device, a cell processing apparatus, a cell washing apparatus, an emergency shower, furniture or instruction manuals, or a combination thereof.

10. A modular cleanroom facility comprising a plurality of cleanrooms according to claim 1.

11. The facility according to claim 10, wherein the plurality of cleanrooms are arranged side-by-side.

12. The facility according to claim 10, wherein the plurality of cleanrooms are stacked on top of one another.

13. The facility according to claim 10, wherein the plurality of cleanrooms are approved for different manufacturing processes.

14. The facility according to claim 10, wherein one or several of the plurality of cleanrooms have removable exterior walls which are removed when two or more cleanrooms are combined to form the facility.

15. The facility according to claim 10, wherein one or several of the plurality of cleanrooms have removable interior walls which can be removed when two or more cleanrooms are combined to form the facility.

16. A method of distributing a modular cleanroom according to claim 1, comprising shipping one or more GMP-approved or GMP-approvable modular cleanrooms with at least one bioreactor, and assembling the one or more modular cleanrooms without requiring further regulatory approval.

17. A method of distributing a modular cleanroom facility according to claim 10, comprising shipping one or more GMP-approved or GMP-approvable modular cleanrooms with at least one bioreactor, and assembling the one or more modular cleanrooms to form a cleanroom facility without requiring further regulatory approval.
